(19) United States
(12) Patent Application Publication
(10) Pub. No.: US 2013/0195351 A1
(43) Pub. Date: Aug. 1, 2013

(54) IMAGE PROCESSOR, IMAGE PROCESSING METHOD, LEARNING DEVICE, LEARNING METHOD AND PROGRAM

(71) Applicant: Sony Corporation, Tokyo (JP)

(72) Inventor: Takehiro Hamada, Kanagawa (JP)

(73) Assignee: Sony Corporation, Tokyo (JP)

(21) Appl. No.: 13/744,805

(22) Filed: Jan. 18, 2013

(30) Foreign Application Priority Data
Jan. 27, 2012 (JP) 2012-014872

(51) Int. Cl. G06K 9/46

(52) U.S. Cl. CPC G06K 9/46
USPC 382/159; 382/201

(57) ABSTRACT

Disclosed herein is an image processor including: a feature point extraction section adapted to extract the feature points of an input image; a correspondence determination section adapted to determine the correspondence between the feature points of the input image and those of a reference image using a feature point dictionary; a feature point coordinate distortion correction section adapted to correct the coordinates of the feature points of the input image corresponding to those of the reference image; a projection relationship calculation section adapted to calculate the projection relationship between the input and reference images; a composite image coordinate transform section adapted to generate a composite Image to be attached from a composite image; and an output image generation section adapted to merge the input image with the composite image to be attached.

### BACKGROUND

The present technology relates to an image processor, image processing method, learning device, learning method and program and, more particularly, to an image processor and so on capable of merging a given image into a specified area of an input image.

Needs for augmented reality have emerged in recent years. Several approaches are available to implement augmented reality. These approaches include that which uses position information from a GPS (Global Positioning System) and that based on image analysis. One among such approaches is augmented reality which merges CG (Computer Graphics) together relative to the posture and position of a specific object using a specific object recognition technique. For example, Japanese Patent Laid-Open No. 2007-219764 describes an image processor based on the estimated result of the posture and position.

Chief among the factors that determine the quality of augmented reality is geometric consistency. The term “geometric consistency” refers to merging of CG into a picture without geometric discomfort. The term “without geometric discomfort” refers, for example, to the accuracy of estimation of the posture and position of a specific object, and to the movement of CG, for example, in response to the movement of an area of interest or to the movement of the camera.

For simplicity of description, we consider below a case in which an image is attached to a specified planar area of CG. For example, we consider a case in which an image is attached to an outdoor advertising board which is a specified area. In order to achieve geometric consistency, it is necessary to estimate the position of the specified area to which the image is to be attached. It is common to define a specific area by using a special two-dimensional code called “marker,” or an arbitrary image. In the description given below, the specified area will be referred to as a marker.

The algorithm used to recognize a marker and attach the image commonly uses a framework which stores the marker data in a program as an image for reference (reference image) or a dictionary representing its features, checks the reference image against an input image and finds the marker in the input image. The approaches adapted to recognize the marker position can be broadly classified into two groups, (1) those based on the precise evaluation of the difference in contrast between the reference and input images, and (2) others based on prior learning of the reference image.

The approaches classified under group (1) are advantageous in terms of estimation accuracy, but are not suitable for real-time processing because of a number of calculations. On the other hand, those classified under group (2) perform a number of calculations and analyze the reference image in prior learning. As a result, there are only a small number of calculations to be performed to recognize the image input at each time point. Therefore, these approaches hold promise of real-time operation.

FIG. 19 illustrates a configuration example of an image processor 400 capable of merging a captured image with a composite image. The image processor 400 includes a feature point extraction section 401, matching section 402, homography calculation section 403, composite image coordinate transform section 404, output image generation section 405 and storage section 406.

The feature point extraction section 401 extracts the feature points of the input image (captured image). Here, the term “feature points” refers to those pixels serving as corners in terms of luminance level. The matching section 402 acquires the corresponding feature points between the two images by performing matching, i.e., calculations to determine whether the feature points of the input image correspond to those of the reference image based on the feature point dictionary of the reference image stored in the storage section 406 and prepared in the prior learning.

The homography calculation section 403 calculates the homography, i.e., the transform between two images, using the corresponding points of the two images found by the matching section 402. The composite image coordinate transform section 404 transforms the composite image stored in the storage section 406 using the homography. The output image generation section 405 merges the input image with the transformed composite image, thus acquiring an output image.

The flowchart shown in FIG. 20 illustrates an example of the process flow of the image processor 400 shown in FIG. 19. First, the image processor 400 begins a series of processes in step ST1, and then is supplied with an input image (captured image) in step ST2, and then proceeds with the process in step ST3.

The image processor 400 uses the feature point extraction section 401 to extract the feature points of the input image in step ST3. Next, the image processor 400 uses the matching section 402 to match the feature points between the input and reference images in step ST4 based on the feature point dictionary of the reference image stored in the storage section 406 and the feature points of the input image extracted by the feature point extraction section 401. This matching process allows the corresponding feature points to be found between the input and reference images.

Next, the image processor 400 uses the homography calculation section 403 to calculate the homography matrix, i.e., the transform between the two images in step ST5, using the corresponding points of the two images found by the matching section 402. Then, the image processor 400 determines in step ST6 whether the homography matrix has been successfully calculated.

When the homography matrix has been successfully calculated, the image processor 400 transforms, in step ST7, the composite image stored in the storage section 406 based on the homography matrix calculated in step ST5. Then, the image processor 400 uses the output image generation section 405 to acquire an output image in step ST8 by merging the input image with the transformed composite image.

Next, the image processor 400 outputs, in step ST9, the output image acquired in step ST8 and then terminates the series of processes in step ST10. On the other hand, if the homography matrix has yet to be successfully calculated in step ST6, the image processor 400 outputs, in step ST11, the input image in an “as-is” manner and then terminates the series of processes in step ST10.

What is technically important in the above matching process is whether the corresponding points can be acquired in a manner robust to the change of the marker posture, for example, due to the rotation of the marker. A variety of approaches has been proposed to acquire the corresponding points in a manner robust to the change of the marker posture. Among the approaches robust to the change of the marker posture are (1) SIFT feature quantity described in D. G. Lowe, “Object recognition from local scale invariant features,” Proc. of IEEE International, and (2) “Random Ferns” described in M. Özuysal, M. Calonder, V. Lepetit, P Fua Fast Keypoint Recognition using Random Ferns IEEE Transactions on Pattern Analysis and Machine Intelligence, Vol. 32, Nr. 3, pp. 448-461, March 2010.

SIFT feature quantity permits recognition in a manner robust to the marker rotation by describing the feature points using the gradient direction of the pixels around the feature points. On the other hand, “Random Ferns” permits recognition in a manner robust to the change of the marker posture by transforming a reference image using Bayesian statistics and learning the reference image in advance.

### SUMMARY

One of the problems with the approaches in the past is that it is difficult for these approaches to support an interlaced input image and deal with a lens distortion. The disadvantage resulting from this problem is that it is necessary to convert the interlaced input image to progressive image and correct the distortion as preprocess of the feature point extraction, thus resulting in a significant increase in calculations.

The cause of this problem is as follows. That is, learning is conducted in consideration of how the target to be recognized appears on the image in the approach based on prior learning. How the target appears on the image is determined by three factors, namely, the change of the posture of the target to be recognized, the change of the posture of the camera and the camera characteristics. However, the approaches in the past do not take into consideration the change of the posture of the camera and the camera characteristics. Of these factors, the change of the posture of the target to be recognized and the change of the posture of the camera are relative, and the change of the posture of the camera can be represented by the change of the posture of the target to be recognized. Therefore, the cause of the problem with the approaches in the past can be summarized as the fact that the camera characteristics are not considered.

FIG. 21 illustrates a configuration example of an image processor 400A adapted to convert the input image (interlaced image) to a progressive image (IP conversion) and correct distortion as preprocess of the feature point extraction. In FIG. 21, like components to those in FIG. 19 are denoted by the same reference numerals, and the detailed description thereof is omitted as appropriate.

The image processor 400A includes an IF conversion section 411 and lens distortion correction section 412 at the previous stage of the feature point extraction section 401. The IP conversion section 411 converts the interlaced input image to a progressive image. On the other hand, the lens distortion correction section 412 corrects the lens distortion of the converted progressive input image based on the lens distortion data stored in the storage section 406. In this case, the lens distortion data represents the lens distortion of the camera that captured the input image. This data is measured in advance and stored in the storage section 406.

Further, the image processor 400A includes a lens distortion transform section 413 and P1 (progressive-to-interlace) conversion section 414 at the subsequent stage of the output image generation section 405. The lens distortion transform section 413 applies a lens distortion transform in such a manner as to add the lens distortion to the output image generated by the output image generation 405 based on the lens distortion data stored in, the storage section 406. As described above, the lens distortion correction section 412 ensures that the output image generated by the output image generation section 405 is free from the lens distortion.

The lens distortion transform section 413 adds back the lens distortion that has been removed, thus restoring the original image intended by the photographer. The PI conversion section 414 converts the progressive output image subjected to the lens distortion transform to an interlaced image and outputs the interlaced image. Although not described in detail, the image processor 400A shown in FIG. 21 is configured in the same manner as the image processor 400 shown in FIG. 19 in all other respects.

The flowchart shown in FIG. 22 illustrates the process flow of the image processor 400A shown in FIG. 21. In FIG. 22, like steps to those shown in FIG. 20 are denoted by the same reference symbols, and the detailed description thereof is omitted as appropriate. The image processor 400A begins a series of processes in step ST1, and then is supplied with an input image, i.e., an interlaced image, in step ST2, and then proceeds with the process in step ST21. In step ST21, the image processor 400A converts the interlaced input image to a progressive image.

Next, the image processor 400A uses the lens distortion correction section 412 to correct the lens distortion of the converted progressive input image in step ST22 based on the lens distortion data stored in the storage section 406. Then, the image processor 400A extracts, in step ST3, the feature points of the converted progressive input image that has been subjected to the lens distortion correction.

Further, the image processor 400A uses the lens distortion transform section 413 to apply, in step ST23 following the process in step ST8, a lens distortion transform to the acquired output image based on the lens distortion data stored in the storage section 406, thus adding the lens distortion to the output image. Next, the image processor 400A converts, in step ST24, the progressive output image, which has been subjected to the lens distortion transform, to an interlaced image.

Then, the image processor 400A outputs, in step ST9, the converted interlaced output image that has been subjected to the lens distortion transform. Although not described in detail, all the other steps of the flowchart shown in FIG. 22 are the same as those of the flowchart shown in FIG. 20.

It is desirable to permit merging of an input image with a composite image in a proper manner.

According to an embodiment of the present technology, there is provided an image processor including: a feature point extraction section adapted to extract the feature points of an input image that is an image captured by a camera; a correspondence determination section adapted to determine the correspondence between the feature points of the input image extracted by the feature point extraction section and the feature points of a reference image using a feature point dictionary generated from the reference image in consideration of a lens distortion of the camera; a feature point coordinate distortion correction section adapted to correct the coordinates of the feature points of the input image corresponding to the feature points of the reference image determined by the correspondence determination section based on lens distortion data of the camera; a projection relationship calculation section adapted to calculate the projection relationship between the input and reference images according to the correspondence determined by the correspondence determination section and based on the coordinates of the feature points of the reference image and the coordinates of the feature points of the input image corrected by the feature point coordinate distortion correction section; a composite image coordinate transform section adapted to generate a composite image to be attached from a composite image based on the projection relationship calculated by the projection relationship calculation section and the lens distortion data of the camera; and an output image generation section adapted to merge the input image with the composite image to be attached generated by the composite image coordinate transform section and acquire an output image.

In the embodiment of the present technology, the feature point extraction section extracts the feature points of an input image. The input image is an image captured by a camera which is, for example, acquired directly from a camera or read from storage. The correspondence determination section determines the correspondence between the extracted feature points of the input image and the feature points of a reference image. That is, the correspondence determination section acquires the corresponding points by matching the feature points of the input and reference images. This determination of the correspondence is conducted by using a feature point dictionary generated from the reference image in consideration of a lens distortion of the camera.

The feature point coordinate distortion correction section corrects the coordinates of the feature points of the input image corresponding to those of the reference image determined by the correspondence determination section based on the lens distortion data of the camera. Then, the projection relationship calculation section calculates the projection relationship (homography) between the input and reference images according to the determined correspondence and based on the coordinates of the feature points of the reference image and the coordinates of the feature points of the input image corrected by the feature point coordinate distortion correction section. Then, the composite image coordinate transform section generates a composite image to be attached from a composite image based on the projection relationship calculated by the projection relationship calculation section and the lens distortion data of the camera. Then, the output image generation section acquires an output image by merging the input image with the generated composite image to be attached.

As described above, the embodiment of the present technology performs matching of the feature points using the feature point dictionary of the reference image that takes into consideration the lens distortion of the camera, thus making it possible to properly find the corresponding feature points of the input and reference images even in the presence of a lens distortion in the input image and allowing merging of the input image with a composite image in a proper manner. In this case, it is not the lens distortion of the input image, but that of the coordinates of the feature points of the input image, that is corrected. This significantly minimizes the amount of calculations.

It should be noted that, in the embodiment of the present technology for example, the feature point dictionary may be generated in consideration of not only the lens distortion of the camera but also an interlaced image. In this case, the feature points are matched using the feature point dictionary of the reference image that takes into consideration the interlaced image. Even if the input image is an interlaced image, the corresponding feature points of the input and reference images can be found properly, thus allowing proper merging of the input image with a composite image, in this case, the interlaced input image is not converted to a progressive image, significantly minimizing the amount of calculations.

According to another embodiment of the present technology, there is provided an image processing method including: extracting the feature points of an input image that is an image captured by a camera; determining the correspondence between the feature points of the input image extracted and the feature points of reference image using a feature point dictionary generated from the reference image in consideration of a lens distortion of the camera; correcting the determined coordinates of the feature points of the input image corresponding to the feature points of the reference image based on lens distortion data of the camera; calculating the projection relationship between the input and reference images according to the determined correspondence and based on the coordinates of the feature points of the reference image and the corrected coordinates of the feature points of the input image; generating a composite image to be attached from a composite image based on the calculated projection relationship and the lens distortion data of the camera; and merging the input image with the generated composite image to be attached and acquiring an output image.

According to further embodiment of the present technology, there is provided a program allowing a computer to function as feature point extraction section adapted to extract the feature points of an input image that is an image captured by a camera; a correspondence determination section adapted to determine the correspondence between the feature points of the input image extracted by the feature point extraction section and the feature points of a reference image using a feature point dictionary generated from the reference image in consideration of a lens distortion of the camera; a feature point coordinate distortion correction section adapted to correct the coordinates of the feature points of the input image corresponding to the feature points of the reference image determined by the correspondence determination section based on lens distortion data of the camera; a projection relationship calculation section adapted to calculate the projection relationship between the input and reference images according to the correspondence determined by the correspondence determination section and based on the coordinates of the feature points of the reference image and the coordinates of the feature points of the input image corrected by the feature point coordinate distortion correction section; a composite image coordinate transform section adapted to generate a composite image to he attached from a composite image based on the projection relationship calculated by the projection relationship calculation section and the lens distortion data of the camera; and an output image generation section adapted to merge the input image with the composite image to he attached generated by the composite image coordinate transform section and acquire an output image.

According to even further embodiment of the present technology, there is provided a learning device including: an image transform section adapted to apply at least a geometric transform using transform parameters and a lens distortion transform using lens distortion data to a reference image; and a dictionary registration section adapted to extract a given number of feature points based on a plurality of images transformed by the image transform section and register the feature points in a dictionary.

In the embodiment of the present technology, the image transform section applies at least a geometric transform using transform parameters and a lens distortion transform using lens distortion data to a reference image. Then, the dictionary registration section extracts a given number of feature points based on a plurality of transformed images and registers the feature points in a dictionary.

For example, the dictionary registration section may include: a feature point calculation unit adapted to find the feature points of the images transformed by the image transform section; a feature point coordinate transform unit adapted to transform the coordinates of the feature points found by the feature point calculation unit into the coordinates of the reference image; an occurrence frequency updating unit adapted to update the occurrence frequency of each of the feature points based on the feature point coordinates transformed by the feature point coordinate transform unit for each of the reference images transformed by the image transform section; and a feature point registration unit adapted to extract, of all the feature points whose occurrence frequencies have been updated by the occurrence frequency updating unit, an arbitrary number of feature points from the top in descending order of occurrence frequency and register these feature points in the dictionary

As described above, the embodiment of the present technology extracts a given number of feature points based on a plurality of transformed images subjected to the lens distortion transform and registers the feature Points in a dictionary, thus making it possible to acquire a feature point dictionary of the reference images that takes into consideration the lens distortion of the camera in a proper manner.

It should be noted that, in the embodiment of the present technology, the image transform section may apply the geometric transform and lens distortion transform to a reference image, and generate the plurality of transformed images by selectively converting the progressive image to an interlaced image. This makes it possible to properly acquire a feature point dictionary that takes into consideration the lens distortion of the camera and both the progressive and interlaced images.

Further, in the embodiment of the present technology, the image transform section may generate a plurality of transformed images by applying the lens distortion transform based on lens distortion data randomly selected from among a plurality of pieces of lens distortion data. This makes it possible to properly acquire a feature point dictionary that takes into consideration the lens distortions of a plurality of cameras.

According to still further embodiment of the present technology, there is provided a learning method including: applying at least a geometric transform using transform parameters and a lens distortion transform using lens distortion data to a reference image; and extracting a given number of feature points based on a plurality of transformed images and registering the feature points in a dictionary.

According to yet further embodiment of the present technology, there is provided a program allowing a computer to function as: an image transform section adapted to apply at least a geometric transform using transform parameters and a lens distortion transform using lens distortion data to a reference image; and a dictionary registration section adapted to extract a given number of feature points based on a plurality of images transformed by the image transform section and register the feature points in a dictionary.

The embodiments of the present technology allow proper merging of an input image with a composite image.

### BRIEF DESCRIPTION OF THE DRAWINGS

FIG. 1 is a block diagram illustrating a configuration example of an image processing system according to an embodiment of the present technology;

FIG. 2 is a block diagram illustrating a configuration example of an image processor making up the image processing system;

FIG. 3 is a flowchart illustrating an example of process flow of the image processor;

FIGS. 4A and 4B are diagrams illustrating examples of input and reference images;

FIG. 5 is a diagram illustrating an example of matching of feature points of the input and reference images;

FIGS. 6A and 6B are diagrams illustrating examples of composite and output images;

FIG. 7 is a block diagram illustrating a configuration example of a learning device making up the image processing system;

FIG. 8 is a block diagram illustrating a configuration example of a feature point extraction section making up the learning device;

FIG. 9 is a diagram for describing the occurrence frequencies of feature points;

FIG. 10 is a flowchart illustrating an example of process flow of the feature point extraction section;

FIG. 11 is a block diagram illustrating a configuration example of an image feature learning section making up the learning device;

FIG. 12 is a flowchart illustrating an example of process flow of the image feature learning section;

FIG. 13 is a flowchart illustrating an example of process flow of the feature point extraction section if the step is included to determine whether a progressive image is converted to an interlaced image;

FIG. 14 is a flowchart illustrating an example of process flow of the image feature learning section if the step is included to determine whether a progressive image is converted to an interlaced image;

FIG. 15 is a flowchart illustrating an example of process flow of the feature point extraction section if a transformed image is used which has been subjected to lens distortion transforms of a plurality of cameras;

FIG. 16 is a flowchart illustrating an example of process flow of the image feature learning section if a transformed image is used which has been subjected to lens distortion transforms of a plurality of cameras;

FIG. 17 is a flowchart illustrating an example of process flow of the feature point extraction section if the step is included to determine whether a progressive image is converted to an interlaced image and if a transformed image is used which has been subjected to lens distortion transforms of a plurality of cameras;

FIG. 18 is a flowchart illustrating an example of process flow of the image feature learning section if the step is included to determine whether a progressive image is converted to an interlaced image and if a transformed image is used which has been subjected to lens distortion transforms of a plurality of cameras;

FIG. 19 is a block diagram illustrating a configuration example of the image processor capable of merging a captured image with a composite image;

FIG. 20 is a flowchart illustrating an example of process flow of the image processor;

FIG. 21 is a block diagram illustrating another configuration example of an image processor capable of merging a captured image with a composite image; and

FIG. 22 is a flowchart illustrating an example of process flow of the image processor according to another configuration example.

### DETAILED DESCRIPTION OF THE PREFERRED EMBODIMENT

A description will be given below of the mode for carrying out the present technology (hereinafter referred to as the embodiment). The description will be given in the following order.
1. Embodiment
2. Modification examples

### 1. EMBODIMENT

### Configuration Example of the Image Processing System

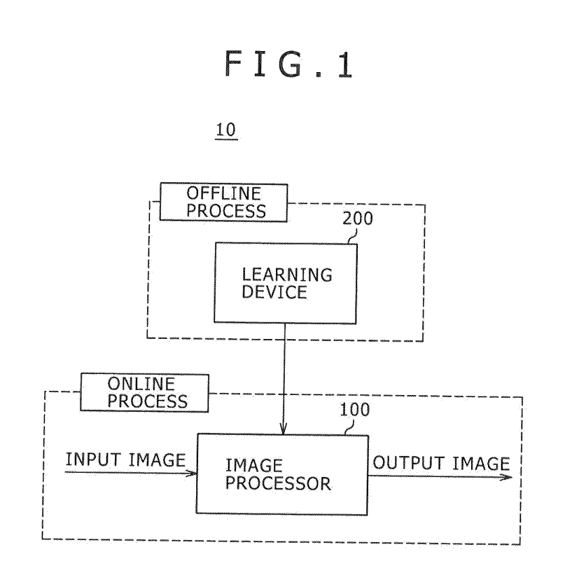

FIG. 1 illustrates a configuration example of an image processing system 10 as an embodiment. The image processing system 10 includes an image processor 100 and learning device 200.

The learning device 200 generates a feature point dictionary as a database by extracting image features of reference image. At this time, the learning device 200 extracts image features in consideration of the change of the posture of the target to be recognized and the camera characteristics. As described above, the analysis of the reference image by the learning device 200 permits recognition robust to the change of the posture of the target to be recognized and suited to the camera characteristics. The processes of the learning device are performed offline, and realtimeness is not necessary. The image processor 100 detects the position of the target to be recognized in an input image using a feature point dictionary and superimposes a composite image at that position, thus generating an output image. The processes of the image processor 100 are performed online, and realtimeness is necessary.

### Detailed Description of the Image Processor

A detailed description will be given below of the image processor 100. The process of the image processor 100 will be outlined first. The objective of the image processor 100 is to attach a composite image to the target to be recognized (marker) within an input image so as to generate an output image. In order to determine how a composite image is to be attached, it is only necessary to find the geometric transform of a reference image to the target to be recognized in the input image and transform the composite image.

In the embodiment of the present technology, the target to he recognized is treated as a plane. Therefore, the above geometric transform is represented by a three-by-three matrix called a homography. It is known that a homography can he found if four or more corresponding points (identical points) are available in the target to be recognized within the input image and in the reference image. The process adapted to search for the correspondence between the points is generally called matching. Matching is performed using a dictionary acquired by the learning device 200. Further, the points serving as corners in terms of luminance level and called feature points are used as the points to provide higher matching accuracy. Therefore, it is necessary to extract feature points of the input and reference images. Here, the feature points of the reference image are found in advance by the learning device 200.

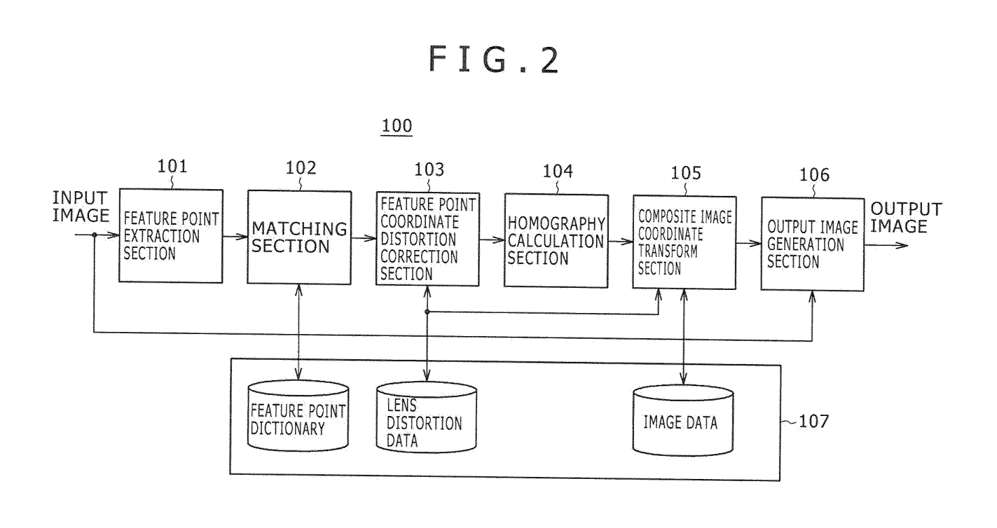

A description will be given next of the detailed configuration of the image processor 100. FIG. 2 illustrates a configuration example of the image processor 100. The image processor 100 includes a feature point extraction section 101, matching section 102, feature point coordinate distortion correction section 103, homography calculation section 104, composite image coordinate transform section 105 and output image generation section 106. It should be noted that the image processor 100 may be integrated with an image input device such as camera or image display device such as display.

The feature point extraction section 101 extracts feature points of the input image (captured image), thus acquiring the coordinates of the feature points. In this case, the feature point extraction section 101 extracts feature points from the frame of the input image at a certain time. Various feature point extraction techniques have been proposed including Harris Corner and SIFT (Scale Invariant Feature Transform). Here, an arbitrary technique can be used.

The matching section 102 performs matching, i.e., calculations to determine whether the feature points of the input image correspond to those of the reference image, based on a feature point dictionary of the reference image stored in a storage section 107 and prepared in prior learning by the learning device 200, thus acquiring the corresponding feature points between the two images. Here, the feature point dictionary has been generated in consideration of not only the camera lens distortion but also both the interlaced and progressive images.

Various approaches have been proposed for matching. Here, an approach based on generally well known Bayesian statistics is, for example, used. This approach based on Bayesian statistics regards the feature points of the reference image that satisfy Equation (1) shown below as the corresponding points.

k=argmaxₖP(Iₖ|f₁,f₂, . . . , f_{N}) (1)

Here, we let I_k be denoted by the kth feature point. f_{—}1 to f_N represent the tests performed on the feature point. The term “tests” refers to the operations performed to represent the texture around the feature point. For example, the magnitude relationship between the feature point and a point therearound is used. Two points of each of N pairs, i.e., the feature point and one of f_{—}1 to f_N, are compared in terms of magnitude Various other approaches are also available for testing including sum of absolute differences (SAD) and comparison of histogram. Here also, an arbitrary method can be used.

Equation (1) means that each of f_{—}1 to f_N is tested (compared in magnitude) with a certain feature point of the input image, and that a feature point I_k of the reference image where a probability distribution P is maximal as a result therefrom is determined to he the corresponding point. At this time, the distribution P is necessary. This distribution is found in advance by the learning device 200. The distribution P is called dictionary. Using Equation (1) in an “as-is” manner leads to an enormous amount of dictionary data. Therefore, statistical independence or assumption pursuant thereto is generally made for P0(f_{—}1) to P(f_N), followed by approximation using, for example, the product of a simultaneous distribution. Here, such an approximation can be used.

The feature point coordinate distortion correction section 103 corrects, based on the camera lens distortion data stored in the storage section 107, the coordinate distortion of the feature point of the input image for which a corresponding point has been found by the matching section 102. The homography calculation section 104 calculates the homography (projection relationship) between the input and reference images at the corresponding point found by the matching section 102 based on the coordinates of the feature point of the reference image and the corrected coordinates of the feature point of the input image. Various approaches have been proposed to find the homography. Here, an arbitrary approach can be used.

The composite image coordinate transform section 105 generates a composite image to be attached from the composite image stored in the storage section 107 based on the homography calculated by the homography calculation section 104 and the camera lens distortion data stored in the storage section 107. In this case, letting the three-dimensional coordinates of the composite image be denoted by X_{g}, the homography by H, and the lens distortion transform by TR, the coordinates X′_{g} after the coordinate transform can be expressed by Equation (2) shown below. It should be noted, however, that TM in Equation (2) is expressed by Equation (3) shown below.

$$\begin{matrix}{X}_{g}^{′} = {T}_{R} ( {T}_{M} ( {HX}_{g} ) ) & ( 2 ) \\ {T}_{M} : {[ a b c ]}^{T} \to {[ \frac{a}{c} \frac{b}{c} 1 ]}^{T} & ( 3 )\end{matrix}$$

In this case, a composite image S′_{g} after the coordinate transform is expressed by Equation (4) shown below.

S′_{g}(X′_{g})=S_{g}(T_{M}(X_{g})) (4)

The output image generation section 106 merges the input image with the transformed composite image to be attached that has been generated by the composite image coordinate transform section 105, thus acquiring an output image. In this case, letting the input image be denoted by S and the blend ratio for merging by α, an output image Sₒ is expressed by Equation (5) shown below.

Sₒ=αS′_{g}+(1−α)S (5)

Each component of the image processor 100 is configured as hardware such as circuit logic and/or software such as program. Each of the components configured as software is implemented, for example, by the execution of the Program on the CPU (central processing unit) which is not shown.

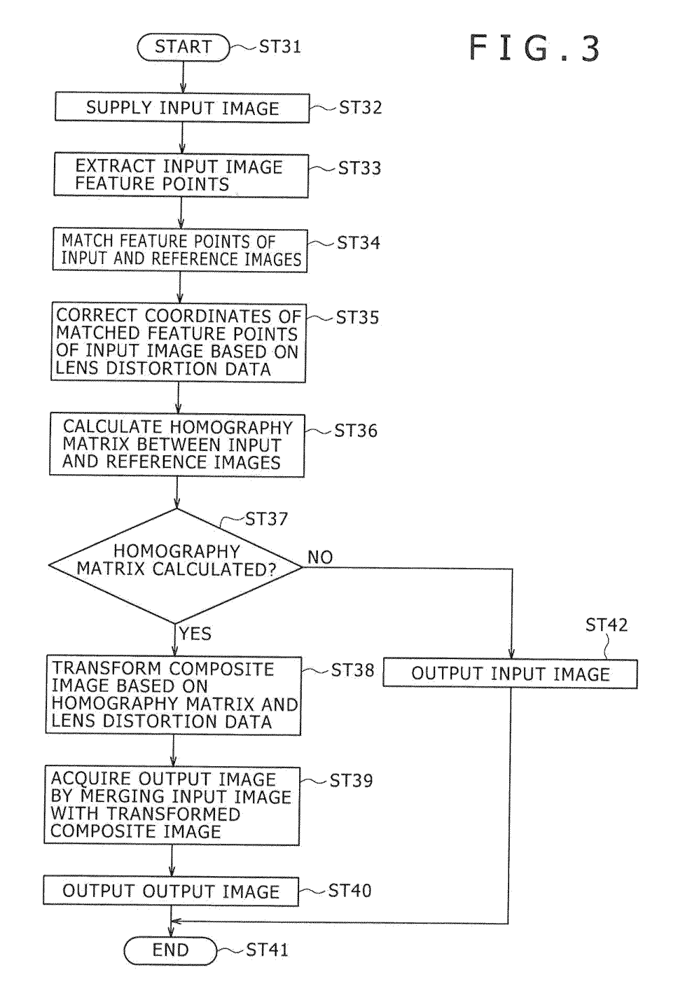

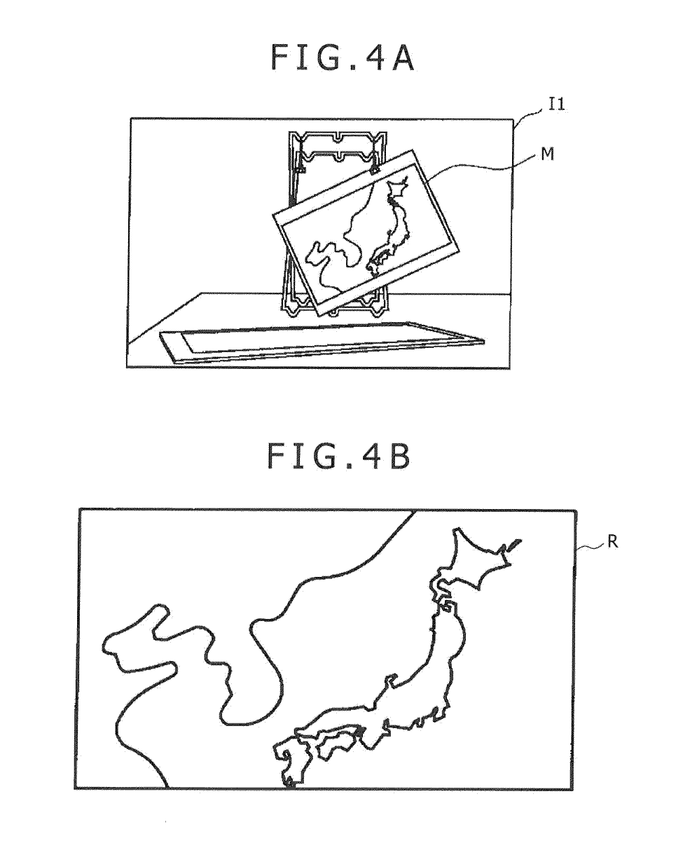

The flowchart shown in FIG. 3 illustrates an example of process flow of the image processor 100 shown in FIG. 2. First, the image processor 100 begins a series of processes in step ST31, and then is supplied with an input image (captured image) in step ST32, and then proceeds with the process in step ST33. FIG. 4A illustrates an example of an input image I1. The input image I1 contains an image of a map suspended diagonally as a marker M.

The image processor 100 uses the feature point extraction section 101 to extract the feature points of the input image in step ST33. Next, the image processor 100 uses the matching section 102 to match the feature points between the input and reference images in step ST34 based on the feature point dictionary of the reference image stored in the storage section 107 and the feature points of the input image extracted by the feature point extraction section 101. This matching process allows the corresponding feature points to be found between the input and reference images.

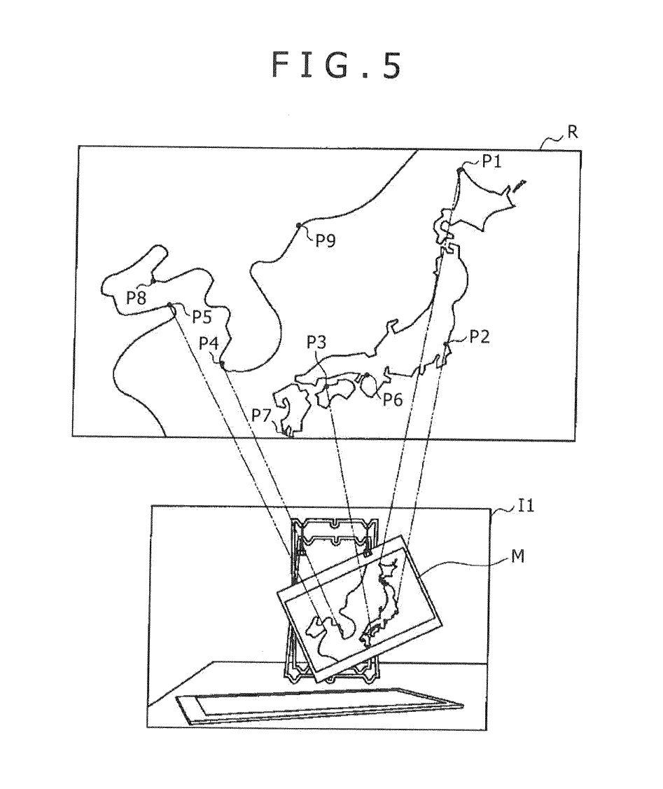

FIG. 4B illustrates an example of a reference image R. On the other hand, FIG. 5 illustrates an example of matching of feature points. In this example, a specific area (marker M) in the input image I1 is specified by the reference image R showing an image of a map of Japan and the surrounding areas. The input image I1 is a diagonal front view of the diagonally suspended map image (marker M). The reference image R is a map image corresponding to the upright marker M, and nine feature points P1 to P9 have been extracted in advance including the edge component of the luminance level.

It should be noted that, in FIG. 5, the feature points P are shown on the map image itself rather than on the luminance image of the map image. This example shows that the five feature points P1 to P5 of the nine feature points P1 to P9 have been matched between the reference image R and input image I1 as indicated by the line segments connecting the identical feature points P that correspond to each other (corresponding points).

The image processor 100 uses the feature point coordinate distortion correction section 103 to correct, based on the camera lens distortion data stored in the storage section 107, the coordinates of the matched feature points of the input image in step ST35. Then, the image processor 100 calculates the homography matrix between the input and reference images in step ST36 based on the coordinates of the feature points of the reference image and the corrected coordinates of the feature points of the input image.

Next, the image processor 100 determines in step ST37 whether the homography matrix has been successfully calculated. When the homography matrix has been successfully calculated, the image processor 100 transforms, in step ST38, the composite image stored in the storage section 107 based on the homography matrix calculated in step ST36 and the camera lens distortion data stored in the storage section 107, thus acquiring a composite image to be attached.

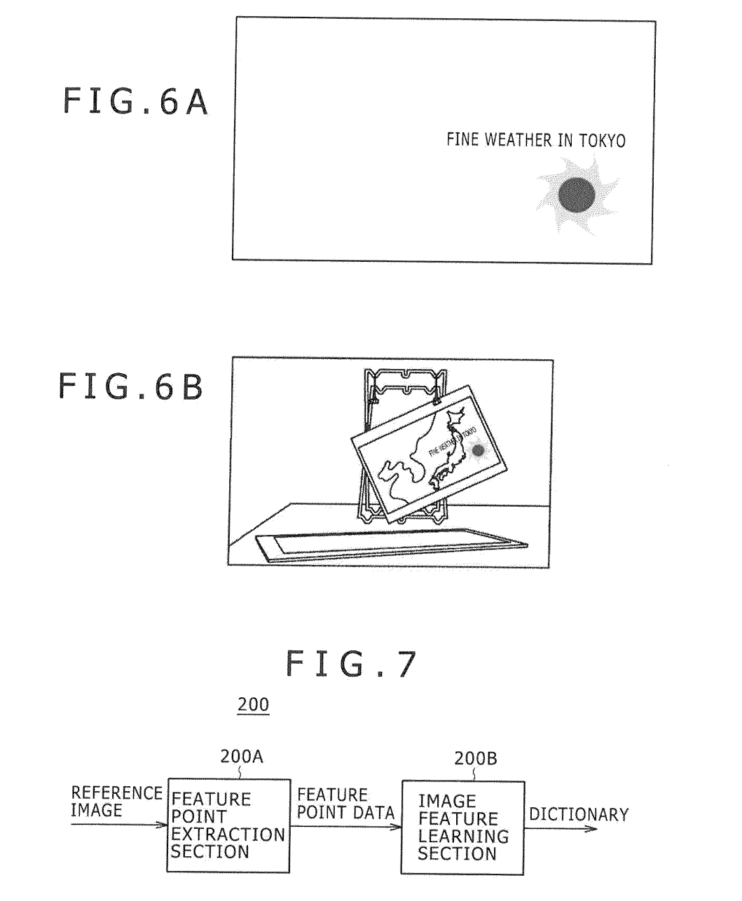

Next, the image processor 100 uses the output image generation section 106 to merge, in step ST39, the input image with the transformed composite image (composite image to be attached) that has been generated in step ST38, thus acquiring an output image. FIG. 6A illustrates an example of a composite image. On the other hand, FIG. 6B illustrates an example of an output image acquired by merging the input image I1 with the transformed composite image.

Further, the image processor 100 outputs, in step ST40, the output image acquired in step ST39, and then terminates the series of processes in step ST41. On the other hand, if the homography matrix has yet to be successfully calculated in step ST37, the image processor 100 outputs the input image in an “as-is” manner in step ST42, and then terminates the series of processes in step ST41.

As described above, the feature point dictionary used by the matching section 102 of the image processor 100 shown in FIG. 2 takes into consideration the camera lens distortion. This makes it possible, even in the presence of lens distortion in the input image, for the image processor 100 to match the feature points in consideration of the lens distortion, thus allowing the corresponding feature points between the input and reference images to be found properly and permitting an input, image to be properly merged with a composite image. Further, in this case, the lens distortion of the input image is not corrected. Instead, the feature point coordinate distortion correction section 103 corrects the lens distortion of the coordinates of the feature points of the input image, significantly minimizing the amount of calculations.

Still further, the feature point dictionary used by the matching section 102 is generated in consideration of an interlaced image. Therefore, even if the input image is an interlaced image, the image processor 100 matches the feature points in consideration of the interlaced image, thus allowing the corresponding feature points between the input and reference images to be found properly and permitting an input image to be properly merged with a composite image. Still further, in this case, the interlaced input image is not converted to a progressive image, significantly minimizing the amount of calculations.

### Detailed Description of the Learning Device

A detailed description will be given below of the learning device 200. The learning device 200 includes a feature point extraction section 200A and image feature learning section 200B. The feature point extraction section 200A calculates the set of feature points robust to the change of the posture of the target to be recognized and the camera characteristics. The image feature learning section 200B analyzes the texture around each of the feature points acquired by the feature point extraction section 200A, thus preparing a dictionary.

### Detailed Description of the Feature Point Extraction Section

A description will be given below of the feature point extraction section 200A. The feature point extraction section 200A is designed to calculate the set of robust feature points. For this reason, the feature point extraction section 200A repeats, a plurality of times, a cycle of applying various transforms to the reference image and then finding the feature points while at the same time randomly changing the transform parameters. After repeating the above cycle a plurality of times, the feature point, extraction section 200A registers the feature points found to occur frequently as a result of repeating the above cycle a plurality of times as the robust feature points in the dictionary.

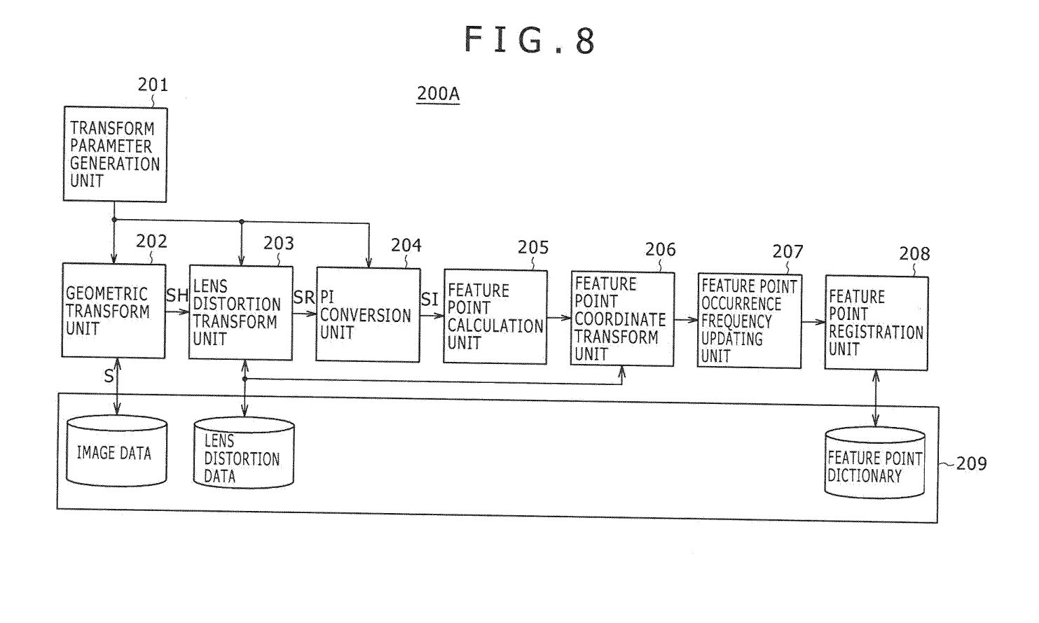

FIG. 8 illustrates a configuration example of the feature point extraction section 200A. The feature point extraction section 200A includes a transform parameter generation unit 201, geometric transform unit 202, lens distortion transform unit 203, PI conversion unit 204, feature point calculation unit 205, feature point coordinate transform unit 206, feature point occurrence frequency updating unit 207, feature point registration unit 208 and storage unit 209.

The transform parameter generation unit 201 generates a transform parameter H (equivalent to the rotation angle and scaling factor) used by the geometric transform unit 202, δₓ and δ_{y} (lens center) parameters used by the lens distortion transform unit 203, and δᵢ (whether to use odd or even fields) parameter used by the PI conversion unit 204. In this case, each of the parameters is generated as a random value using a random number.

The geometric transform unit 202 rotates the reference image S stored in the storage unit 209, scales it or manipulates it in other way by means of a transform TH equivalent to the change of the posture of the target to be tracked, thus acquiring a transformed image SH=TH (S, H). Affine transform, homographic transform or other transform is used as the transform TH depending on the estimated class of the change of the posture. The transform parameters are determined randomly to fall within the estimated range of change of the posture.

The lens distortion transform unit 203 applies a transform TR equivalent to the camera lens distortion to the image SH based on the lens distortion data stored in the storage unit 209, thus acquiring a transformed image SR=TR (SH, δₓ, δ_{y}). At this time, the lens distortion transform unit 203 applies the transform assuming that the lens center has moved by δₓ in the x direction and by δ_{y} in the y direction from the center of the reference image. The δₓ and δ_{y} parameters are determined randomly to fall within the estimated range of change of the lens center. It should be noted that the lens distortion transform unit 203 finds the transform TR by measuring the lens distortion in advance.

The PI conversion unit 204 applies a transform TI to the image SR, thus converting the progressive image SR to an interlaced image and acquiring a transformed image SI=TI (SR, δᵢ). In this case, the transform TI is down-sampling, and various components such as filters can be used. At this time, the value δᵢ determines whether odd or even fields are used. The feature point calculation unit 205 calculates the feature points of the image SI. The feature point coordinate transform unit 206 reverses the TH and TR transforms and TI conversion on each of the feature points, thus finding the feature point coordinates on the reference image S.

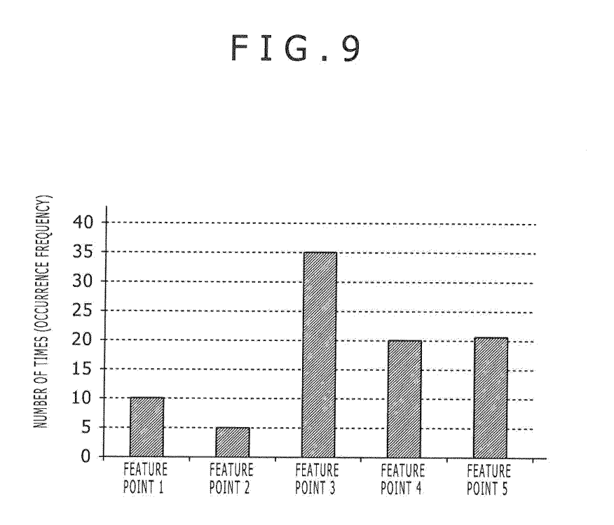

The feature point occurrence frequency updating unit 207 updates the occurrence frequencies of the feature points at each set of coordinates on the reference image S. The frequencies of occurrence are plotted in a histogram showing the frequency of occurrence of each of the feature points as illustrated in FIG. 9. The determination as to what number feature point a certain feature point is is made by the coordinates of the feature point on the reference image S. The reason for this is that the feature point coordinates on the reference image S are invariable quantities regardless of the transform parameters. The feature point registration unit 208 registers an arbitrary number of feature points from the top in descending order of occurrence frequency in the feature point dictionary of the storage unit 209 based on the feature point occurrence frequencies found as a result of the feature point extractions performed N times on the transformed image.

Each component of the feature point extraction section 200A is configured as hardware such as circuit logic and/or software such as program. Each of the components configured as software is implemented, for example, by the execution of the program on the CPU which is not shown.

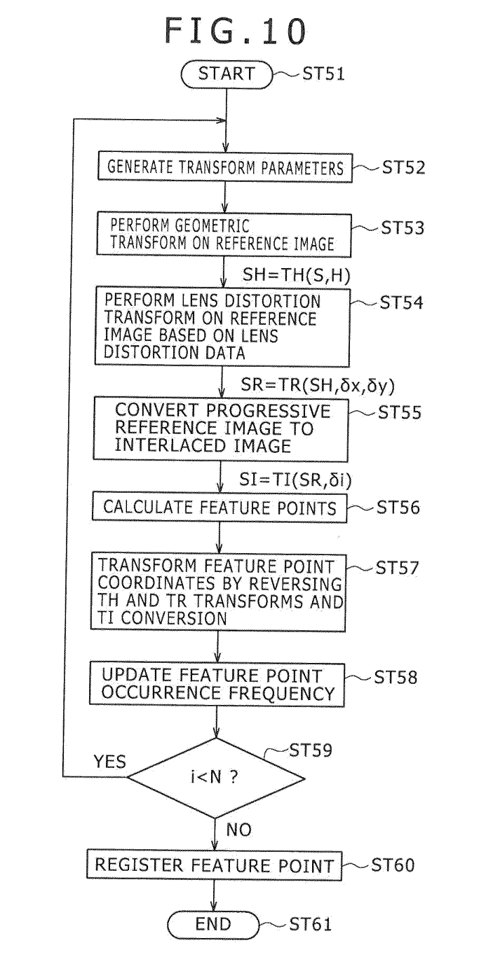

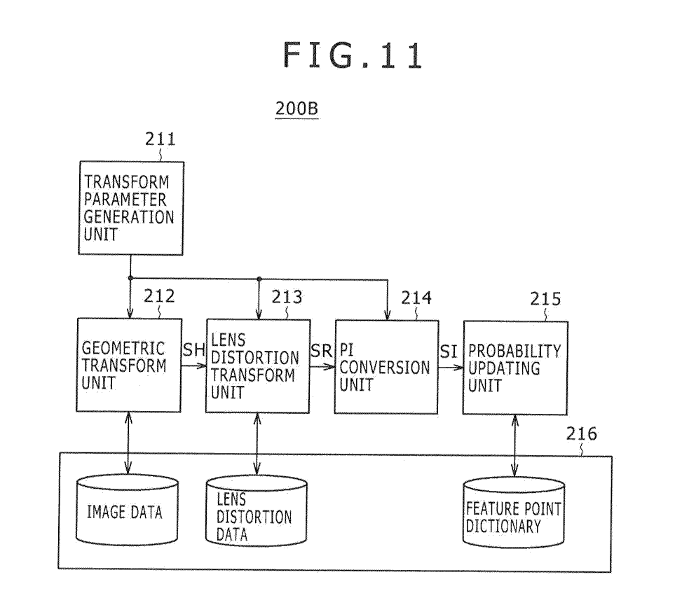

The flowchart shown in FIG. 10 illustrates an example of process flow of the feature point extraction section 200A shown in FIG. 8. First, the feature point extraction section 200A begins a series of processes in step ST51, and then uses the transform parameter generation unit 201 to generate, in step ST52, the transform parameters as random values using random numbers. The transform parameters generated here are the transform parameter H (equivalent to the rotation angle and scaling factor) used by the geometric transform unit 202, δₓ and δ_{y} (lens center) parameters used by the lens distortion transform unit 203, and δᵢ (whether to use odd or even fields) parameter used by the PI conversion unit 204.

Next, the feature point extraction section 200A uses the geometric transform unit 202 to rotate the reference image S, scale it or manipulate it in other way in step ST53 based on the transform parameter H and by means of the transform TH equivalent to the change of the posture of the target to be tracked, thus acquiring the transformed image SH=TH (S, H). Further, the feature point extraction section 200A applies the transform TR equivalent to the camera lens distortion to the image SR in step ST54, thus acquiring the transformed image SR TR (SH, δₓ, δ_{y}). Still further, the feature point extraction section 200A applies, in step ST55, the transform TI to the image SR, thus converting the progressive image SR to an interlaced image and acquiring the transformed image SI=TI (SR, δᵢ).

Next, the feature point extraction section 200A uses the feature point calculation unit 205 to calculate, in step ST56, the feature points of the image SI acquired in step ST55. Then, the feature point extraction section 200A uses the feature point coordinate transform unit 206 to reverse, in step ST57, the TH and TR transforms and TI conversion on each of the feature points of the image SI found in step ST56, thus finding the feature point coordinates on the reference image S. Then, the feature point extraction section 200A uses the feature point occurrence frequency updating unit 207 to update, in step ST58, the occurrence frequency of each of the feature points at each set of coordinates on the reference image S.

Next, the feature point extraction section 200A determines, in step ST59, whether the series of processes has been completed the Nth time. If the series of processes has yet to be completed the Nth time, the feature point extraction section 200A returns to the process in step ST52 to repeat the same processes as described above. On the other hand, when the series of processes has been completed the Nth time, the feature point extraction section 200A uses the feature point registration unit 208 to register, in step ST60, an arbitrary number of feature points from the top in descending order of occurrence frequency in the dictionary based on the feature point occurrence frequencies. Then, the feature point extraction section 200A terminates the series of processes in step ST61,

### Detailed Description of the Image Feature Learning Section

A description will be given below of the image feature learning section 200B. The image feature learning section 200B is designed to prepare a dictionary by analyzing the image feature around each of the feature points acquired by the feature point extraction section 200A. At this time, the image feature learning section 200B prepares a dictionary by applying various transforms to the reference image as does the feature point extraction section 200A, thus permitting recognition robust to the change of the posture of the target to be recognized and the camera characteristics.

The image feature learning section 200B includes a transform parameter generation unit 211, geometric transform unit 212, lens distortion transform unit 213, PI conversion unit 214, probability updating unit 215 and storage unit 216. The transform parameter generation unit 211 generates the transform parameter H (equivalent to the rotation angle and scaling factor) used by the geometric transform unit 212, δₓ and δ_{y} (lens center) parameters used by the lens distortion transform unit 213, and δᵢ (whether to use odd or even fields) parameter used by the PI conversion unit 214. In this case, each of the parameters is generated as a random value using a random number.

Although not described in detail, the geometric transform unit 212, lens distortion transform unit 213 and PI conversion unit 214 are configured respectively in the same manner as the geometric transform unit 202, lens distortion transform unit 203 and PI conversion unit 204 of feature point extraction section 200A shown in FIG. 8.

The probability updating unit 215 performs the same tests as described in relation to the matching section 102 of the image processor 100 shown in FIG. 2 on each of the feature points acquired from the transformed image SI by the feature point extraction section 200A, thus updating the probabilities (dictionary) of the feature points stored in the storage unit 216. The probability updating unit 215 updates the probabilities (dictionary) of the feature points at each of the N times the transformed image SI is acquired. As a result, a feature point dictionary compiling the feature points and their probability data is generated in the storage unit 216.

The probability maximization in the above matching performed by the image processor 100 can be given by Equation (6) shown below using Bayesian statistics. From this, the maximization is achieved if P(f_{—}1, f_{—}2, . . . , f_N)|I_k) and P(I_k) are found.

$$\begin{matrix}k = {argmax}_{k} P ( {I}_{k} \vert {f}_{1} , {f}_{2} , … , {f}_{N} ) \\ = {argmax}_{k} P ( {I}_{k} ) P ( {f}_{1} , {f}_{2} , … , {f}_{N} \vert {I}_{k} )\end{matrix} \qquad ( 6 )$$

Here, P(f_{—}1, f_{—}2, . . . , f_N)|I_k) is the probability that can be achieved by the tests for the feature point I_k, and P(I_k) the probability of occurrence of I_k. The former can be found by performing the above tests on each of the feature points. The latter corresponds to the feature point occurrence frequency found by the feature point extraction section 200A. Each of all the feature points is tested.

Each component of the image feature learning section 200B is configured as hardware such as circuit logic and/or software such as program. Each of the components configured as software is implemented, for example, by the execution of the program on the CPU which is not shown.

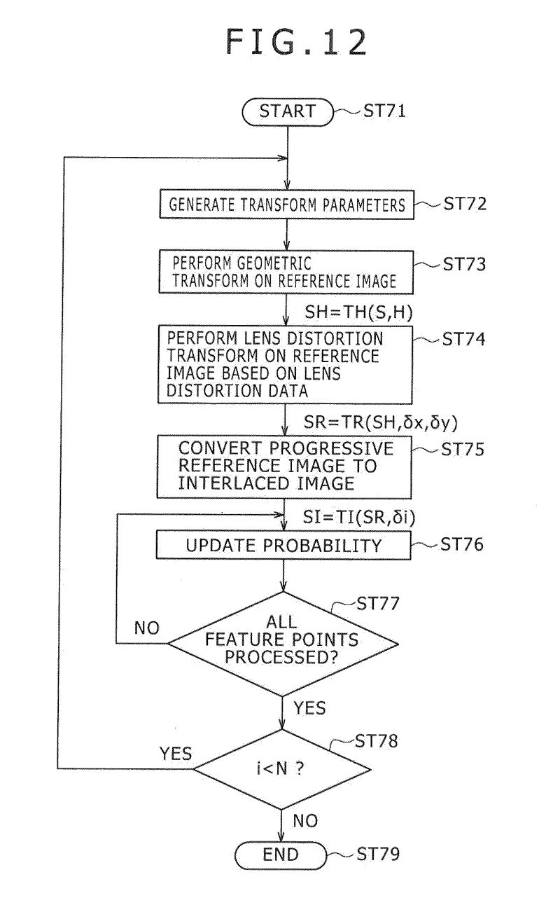

The flowchart shown in FIG. 12 illustrates an example of process flow of the image feature learning section 200B shown in FIG. 11. First, the image feature learning section 200B begins a series of processes in step ST71, and then uses the transform parameter generation unit 211 to generate, in step ST72, the transform parameters as random values using random numbers. The transform parameters generated here are the transform parameter H (equivalent to the rotation angle and scaling factor) used by the geometric transform unit 212, δₓ and δ_{y} (lens center) parameters used by the lens distortion transform unit 213, and δᵢ (whether to use odd or even fields) parameter used by the PI conversion unit 214.

Next, the image feature learning section 200B uses the geometric transform unit 212 to rotate the reference image S, scale it or manipulate it in other way in step ST73 based on the transform parameter H and by means of the transform TH equivalent to the change of the posture of the target to be tracked, thus acquiring the transformed image SH=TH (S, H). Further, the image feature learning section 200B applies the transform TR equivalent to the camera lens distortion to the image SH in step ST74, this acquiring the transformed image SR=TR (SH, δₓ, δ_{y}). Still further, the image feature learning section 200B applies, in step ST75, the transform TI to the image SR, thus converting the progressive image SR to an interlaced image and acquiring the transformed image SI=TI (SR, δᵢ).

Next, the image feature learning section 2002 uses the probability updating unit 215 to test, in step ST76, each of the feature points acquired by the feature point extraction section 200A in the transformed image SI acquired in step ST75, thus updating the feature point probabilities (dictionary) stored in the storage unit 216.

Then, the image feature learning section 200B determines, in step ST77, whether all the feature points have been processed. If all the feature points have yet to be processed, the image feature learning section 2005 returns to step ST76 to update the feature point probabilities again. On the other hand, when all the feature points have been processed, the image feature learning section 200B determines, in step ST78, whether the series of processes has been completed the Nth time. If the series of processes has yet to be completed the Nth time, the image feature learning section 200B returns to the process in step ST72 to repeat the same processes as described above. On the other hand, when the series of processes has been completed the Nth time, the image feature learning section 200B terminates the series of processes in step ST79.

As described above, the learning device 200 shown in FIG. 7 extracts a given number of feature points based on a plurality of transformed images subjected to lens distortion transform and registers the feature points in a dictionary. This makes it possible to properly acquire a feature point dictionary of a reference image that takes into consideration the lens distortion of the camera. Further, the learning device 200 shown in FIG. 7 extracts a given number of feature points based on the interlaced image converted from a progressive image and registers the feature points in a dictionary. This makes it possible to properly acquire a feature point dictionary that takes into consideration the interlaced image.

### 2. MODIFICATION EXAMPLES

### Modification Example 1

It should be noted that an example was shown in which the learning device 200 illustrated in FIG. 7 extracts a given number of feature points based on the interlaced image converted from a progressive image and registers the feature points in a dictionary so as to acquire a feature point dictionary that takes into consideration the interlaced image. However, if the step is included to determine whether the progressive image is converted to an interlaced image, it is possible to prepare a dictionary that supports both the progressive and interlaced formats.

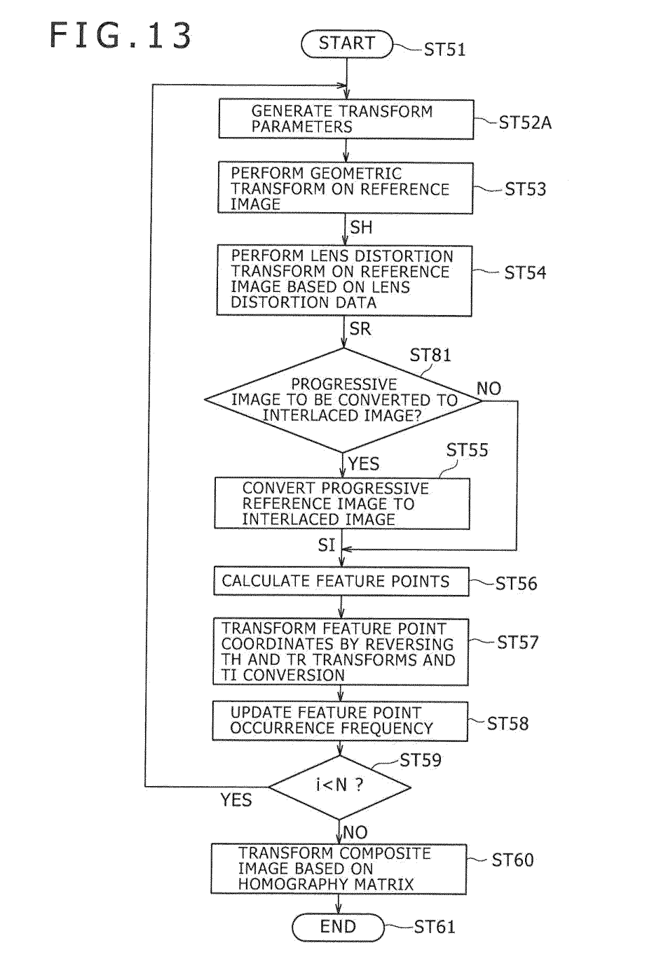

The flowchart shown in FIG. 13 illustrates an example of process flow of the feature point extraction section 200A if the step is included to determine whether the progressive image is converted to an interlaced image. In the flowchart shown in FIG. 13, like steps to those shown in FIG. 10 are denoted by the same reference symbols, and the detailed description thereof is omitted as appropriate.

The feature point extraction section 200A begins a series of processes in step ST51, and then uses the transform parameter generation unit 201 to generate, in step ST52A, the transform parameters as random values using random numbers. The transform parameters generated randomly here are not only the transform parameter H used by the geometric transform unit 202, δₓ and δ_{y} parameters used by the lens distortion transform unit 203, and δᵢ parameter used by the PI conversion unit 204 but also the parameter indicating whether to convert the progressive image to an interlaced image. The feature point extraction section 200A proceeds with the process in step ST53 following the process in step ST52A.

Further, the feature point extraction section 200A proceeds with the process in step ST81 following the process in step ST54. In step ST81, the feature point extraction section 200A determines, based on the parameter indicating whether to convert the progressive image to an interlaced image generated in step ST52A, whether to do so. When the progressive image is converted to an interlaced image, the feature point extraction section 200A applies, in step ST55, the transform TI to the transformed image SR acquired in step ST54, thus converting the progressive image. SR to an interlaced image and acquiring the transformed image SI=TI (SR, δᵢ).

The feature point extraction section 200A proceeds with the process in step ST56 following the process in step ST55. On the other hand, if the progressive image is not converted to an interlaced image in step ST81, the feature point extraction section 200A proceeds immediately with the process in step ST56. Although not described in detail, all the other steps of the flowchart shown in FIG. 13 are the same as those of the flowchart shown in FIG. 10.

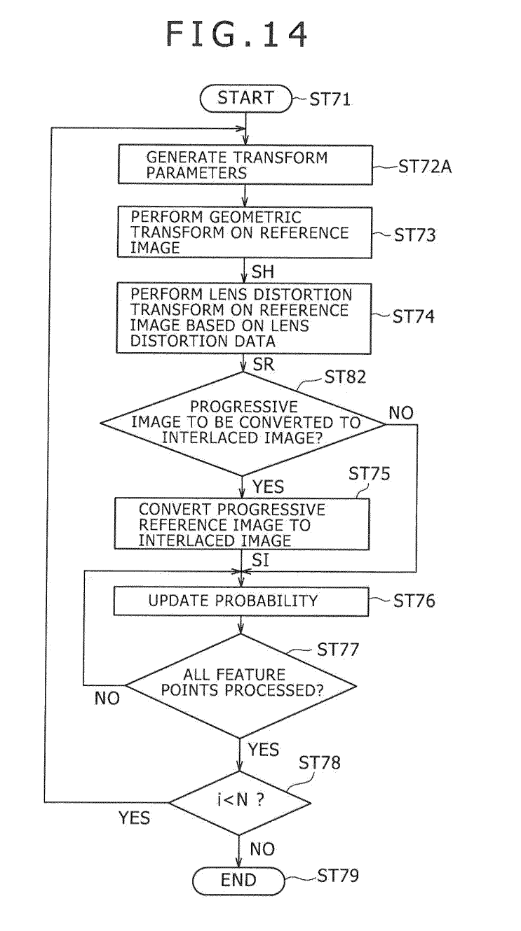

The flowchart shown in FIG. 14 illustrates an example of process flow of the image feature learning section 200B if the step is included to determine whether the progressive image is converted to an interlaced image. In the flowchart shown in FIG. 14, like steps to those shown in FIG. 12 are denoted by the same reference symbols, and the detailed description thereof is omitted as appropriate.

The image feature learning section 200B begins a series of processes in step ST71, and then uses the transform parameter generation unit 211 to generate, in step ST72A, the transform parameters as random values using random numbers. The transform parameters generated randomly here are not only the transform parameter H used by the geometric transform unit 212, δₓ and δ_{y} parameters used by the lens distortion transform unit 213, and δᵢ parameter used by the PI conversion unit 214 but also the parameter indicating whether to convert the progressive image to an interlaced image. The image feature learning section 200B proceeds with the process in step ST73 following the process in step ST72A.

Further, the image feature learning section 200B proceeds with the process in step ST82 following the process in step ST74. In step ST82, the image feature learning section 200B determines, based on the parameter indicating whether to convert the progressive image to an interlaced image generated in step ST72A, whether to do so. When the progressive image is converted to an interlaced image, the image feature learning section 200B applies, in step ST75, the transform TI to the transformed image SR acquired in step ST74, thus converting the progressive image SR to an interlaced image and acquiring the transformed image SI=TI (SR, δᵢ).

The image feature learning section 200B proceeds with the process in step ST76 following the process in step ST75. On the other hand, if the progressive image is not converted to an interlaced image in step ST82, the image feature learning section 200B proceeds immediately with the process in step ST76. Although not described in detail, all the other steps of the flowchart shown in FIG. 14 are the same as those of the flowchart shown in FIG. 12.

As described above, if the step is included to determine whether the progressive image is converted to an interlaced image, it is possible to prepare a dictionary that takes into consideration both the progressive and interlaced images. The image processor 100 shown in FIG. 2 supports both interlaced and progressive input images by using this feature point dictionary, thus eliminating the need to specify the input image format. That is, regardless of whether the input image is an interlaced or progressive image, it is possible to properly find the corresponding feature points between the input and reference images, thus permitting the input image to be properly merged with a composite image.

### Modification Example 2

Further, an example was shown in which the learning device 200 shown in FIG. 7 extracts a given number of feature points based on the transformed image subjected to lens distortion transform of a camera and registers the feature points in a dictionary so as to acquire a feature point, dictionary that takes into consideration the lens distortion of the camera. However, if a transformed image is used which has been subjected to lens distortion transforms of a plurality of cameras, it is possible to prepare a dictionary that takes into consideration the lens distortions of the plurality of cameras.

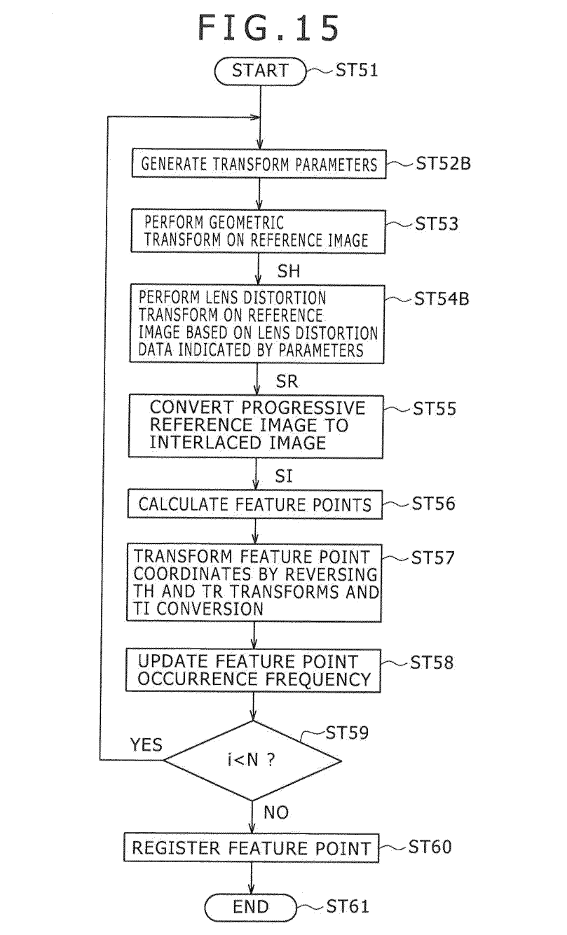

The flowchart shown in FIG. 15 illustrates an example of process flow of the feature point extraction section 200A if a transformed image is used which has been subjected to lens distortion transforms of a plurality of cameras. In the flowchart shown in FIG. 15, like steps to those shown in FIG. 10 are denoted by the same reference symbols, and the detailed description thereof is omitted as appropriate.

The feature point extraction section 200A begins a series of processes in step ST51, and then uses the transform parameter generation unit 201 to generate, in step ST52B, the transform parameters as random values using random numbers. The transform parameters generated randomly here are not only the transform parameter H used by the geometric transform unit 202, δₓ and δ_{y} parameters used by the lens distortion transform unit 203, and δᵢ parameter used by the PI conversion unit 204 but also the parameter indicating which of the plurality of pieces of camera lens distortion data is to be used. It should be noted that the plurality of pieces of camera lens distortion data are measured and registered in the storage unit 209 in advance. The feature point extraction section 200A proceeds with the process in step ST53 following the process in step ST52B.

Further, the feature point extraction section 200A proceeds with the process in step ST54B following the process in step ST53. The feature point extraction section 200A applies, in step ST54B, the lens distortion transform to the image SH acquired by the process in step ST53. In this case, the feature point extraction section 200A applies the transform TR equivalent to the camera lens distortion based on the lens distortion data specified by the parameter indicating which of the plurality of pieces of camera lens distortion data is to be used, thus acquiring the transformed image SR. The feature point extraction section 200A proceeds with the process in step ST55 following the process in step ST54B. Although not described in detail, all the other steps of the flowchart shown in FIG. 15 are the same as those of the flowchart shown in FIG. 10.

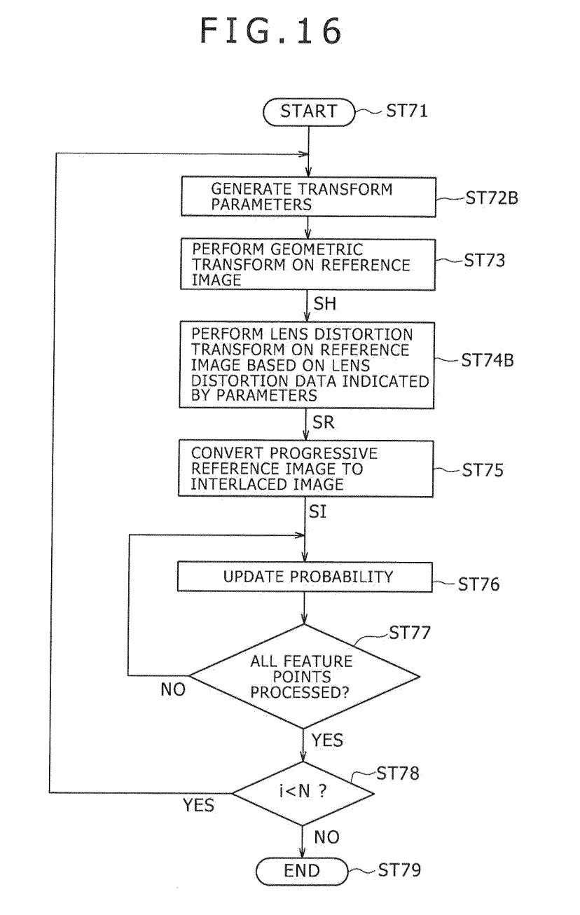

Further, the flowchart shown in FIG. 16 illustrates an example of process flow of the image feature learning section 200B if a transformed image is used which has been subjected to lens distortion transforms of a plurality of cameras. In the flowchart shown in FIG. 16, like steps to those shown in FIG. 12 are denoted by the same reference symbols, and the detailed description thereof is omitted as appropriate.

The image feature learning section 200B begins a series of processes in step ST71, and then uses the transform parameter generation unit 211 to generate, in step ST72B, the transform parameters as random values using random numbers. The transform parameters generated randomly here are not only the transform parameter H used by the geometric transform unit 212, δₓ and δ_{y} parameters used by the lens distortion transform unit 213, and δᵢ parameter used by the PI conversion unit 214 but also the parameter indicating which of the plurality of pieces of camera lens distortion data is to be used. It should be noted that the plurality of pieces of camera lens distortion data are measured and registered in the storage unit 216 in advance. The image feature learning section 200B proceeds with the process in step ST73 following the process in step ST72B.

Further, the image feature learning section 200B proceeds with the process in step ST74B following the process in step ST73. The image feature learning section 200B applies, in step ST74B, the lens distortion transform to the image SH acquired by the process in step ST73. In this case, the image feature learning section 200B applies the transform TR equivalent to the camera lens distortion based on the lens distortion data specified by the parameter indicating which of the plurality of pieces of camera lens distortion data is to be used, thus acquiring the transformed image SR. The image feature learning section 200B proceeds with the process in step ST75 following the process in step ST74B. Although not described in detail, all the other steps of the flowchart shown in FIG. 16 are the same as those of the flowchart shown in FIG. 12.

As described above, if a transformed image is used which has been subjected to lens distortion transforms of a plurality of cameras, it is possible to acquire a feature point dictionary that takes into consideration the lens distortions of a plurality of cameras. The image processor shown in FIG. 2 can deal with any of the plurality of lens distortions by using this feature point dictionary. In other words, regardless of which of the plurality of lens distortions the input image has, it is possible to properly find the corresponding feature points between the input and reference images, thus permitting the input image to be properly merged with a composite image.

### Modification Example 3

If the step is included to determine whether the progressive image is converted to an interlaced image as in modification example 1, it is possible to prepare a dictionary that supports both the progressive and interlaced formats. Further, if a transformed image is used which has been subjected to lens distortion transforms of a plurality of cameras as in modification example 2, it is possible to prepare a dictionary that deals with the lens distortions of a plurality of cameras.

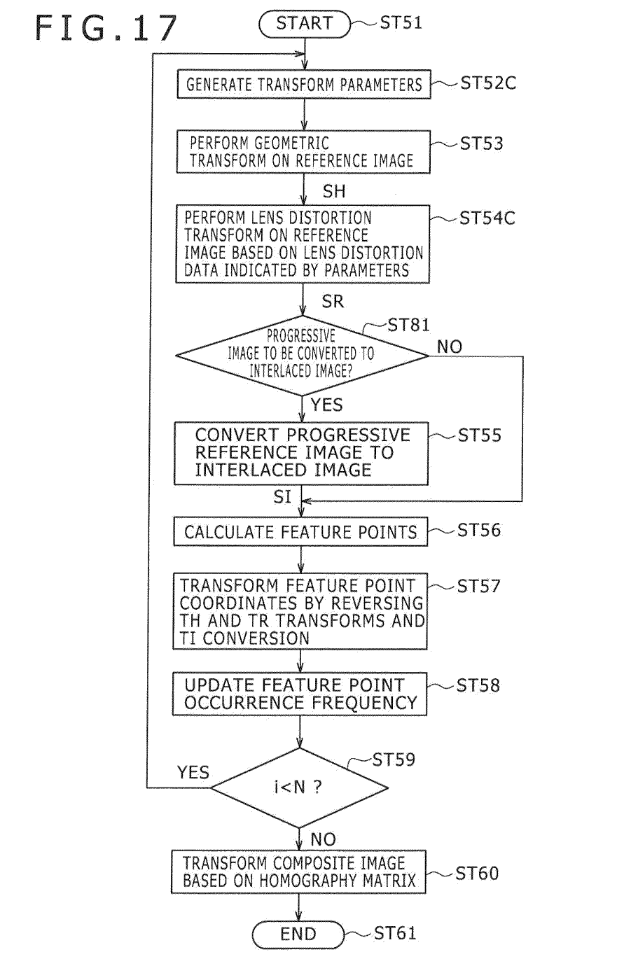

The flowchart shown in FIG. 17 illustrates an example of process flow of the feature point extraction section 200A if the step is included to determine whether a progressive image is converted to an interlaced image and if a transformed image is used which has been subjected to lens distortion transforms of a plurality of cameras. In the flowchart shown in FIG. 17, like steps to those shown in FIG. 10 are denoted by the same reference symbols, and the detailed description thereof is omitted as appropriate.

The feature point extraction section 200A begins a series of processes in step ST51, and then uses the transform parameter generation unit 201 to generate, in step ST52C, the transform parameters as random values using random numbers. The transform parameters generated randomly here are the transform parameter H used by the geometric transform unit 202, δₓ and δ_{y} parameters used by the lens distortion transform unit 203, and δᵢ parameter used by the PI conversion unit 204.

Further, the transform parameters generated randomly here are the parameter indicating whether to convert the progressive image to an interlaced image and the parameter indicating which of the plurality of pieces of camera lens distortion data is to be used. It should be noted that the plurality of pieces of camera lens distortion data are measured and registered in the storage unit 209 in advance. The feature point extraction section 200A proceeds with the process in step ST53 following the process in step ST52C.

Further, the feature point extraction section 200A proceeds with the process in step ST54C following the process in step ST53. The feature point extraction section 200A applies, in step ST54C, the lens distortion transform to the image SH acquired by the process in step ST53. In this case, the feature point extraction section 200A applies the transform TR equivalent to the camera lens distortion based on the lens distortion data specified by the parameter indicating which of the plurality of pieces of camera lens distortion data is to be used, thus acquiring the transformed image SR.

Still further, the feature point extraction section 200A proceeds with the process in step ST81 following the process in step ST54C. In step ST81, the feature point extraction section 200A determines, based on the parameter indicating whether to convert the progressive image to an interlaced image generated in step ST52C, whether to do so. When the progressive image is converted to an interlaced image, the feature point extraction section 200A applies, in step ST55, the transform TI to the transformed image SR acquired in step ST54C, thus converting the progressive image SR to an interlaced image and acquiring the transformed image SI=TI (SR, δᵢ).

The feature point extraction section 200A proceeds with the process in step ST56 following the process in step ST55. On the other hand, if the progressive image is not converted to an interlaced image in step ST81, the feature point extraction section 200A proceeds immediately with the process in step ST56. Although not described in detail, all the other steps of the flowchart shown in FIG. 17 are the same as those of the flowchart shown in FIG. 10.

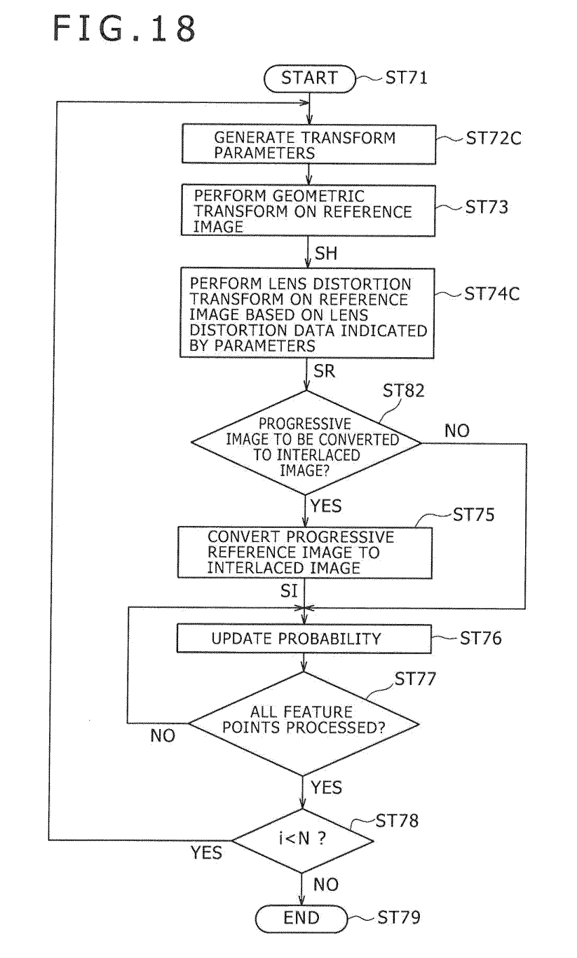

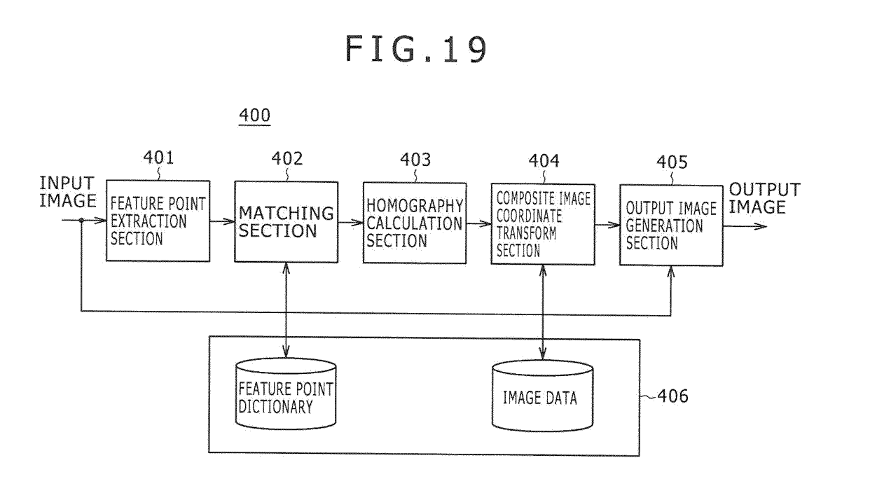

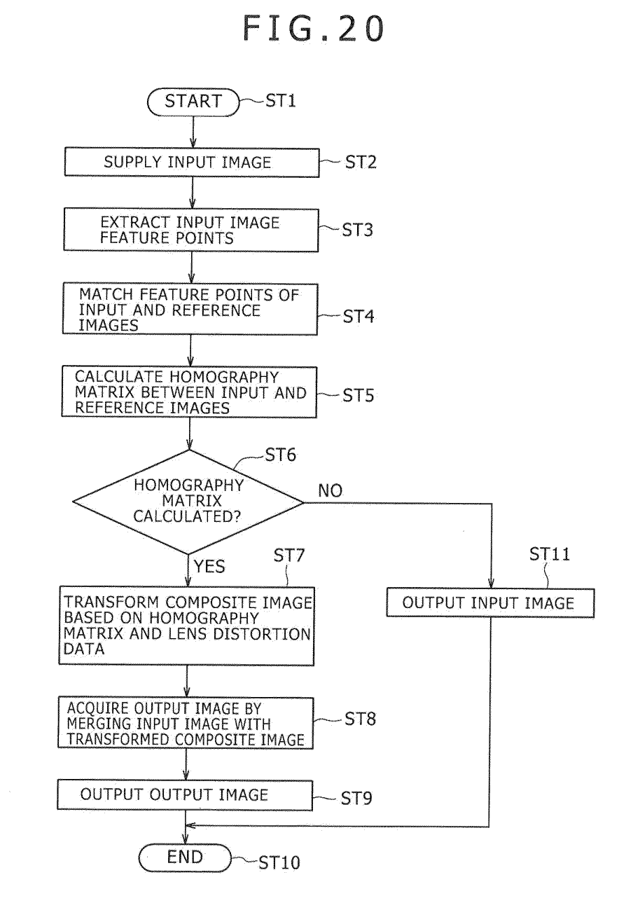

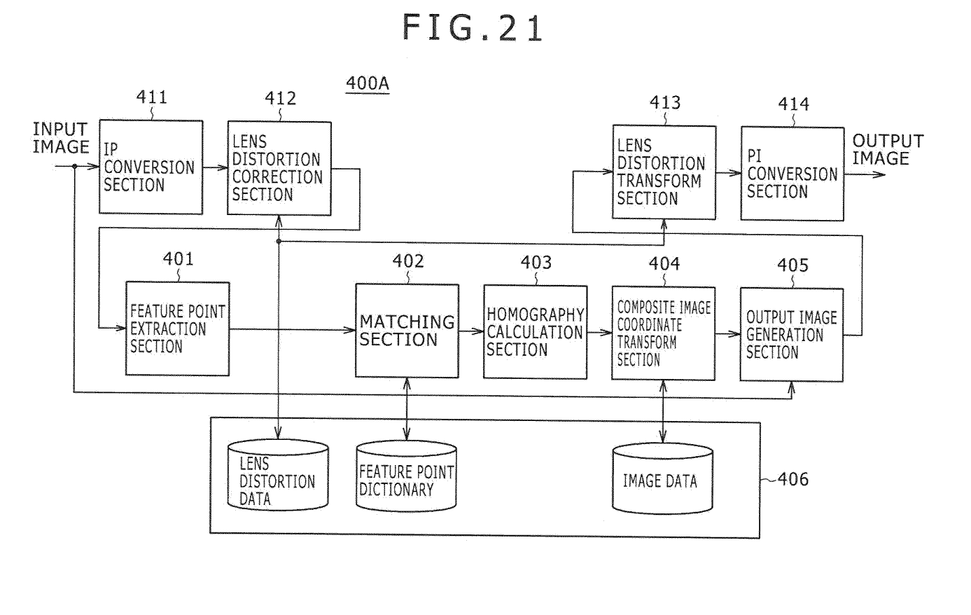

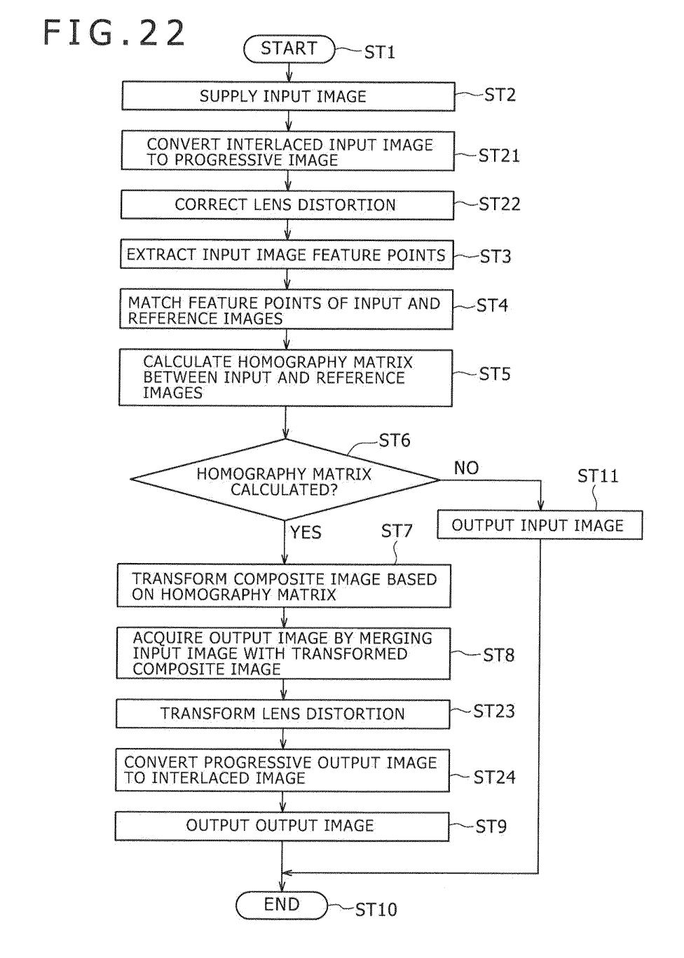

The flowchart shown in FIG. 18 illustrates an example of process flow of the image feature learning section 200B if the step is included to determine whether a progressive image is converted to an interlaced image and if a transformed image is used which has been subjected to lens distortion transforms of a plurality of cameras. In the flowchart shown in FIG. 18, like steps to those shown in FIG. 12 are denoted by the same reference symbols, and the detailed description thereof is omitted as appropriate.

The image feature learning section 200B begins a series of processes in step ST71, and then uses the transform parameter generation unit 211 to generate, in step ST72C, the transform parameters as random values using random numbers. The transform parameters generated randomly here are the transform parameter H used by the geometric transform unit 212, δₓ and δ_{y} parameters used by the lens distortion transform unit 213, and δᵢ parameter used by the PI conversion unit 214.

Further, the transform parameters generated randomly here are the parameter indicating whether to convert the progressive image to an interlaced in and the parameter indicating which of the plurality of pieces of camera lens distortion data is to be used. It should be noted that the plurality of pieces of camera lens distortion data are measured and registered in the storage unit 216 in advance. The image feature learning section 200B proceeds with the process in step ST73 following the process in step ST72C.

Further, the image feature learning section 200B proceeds with the process in step ST74C following the process in step ST73. The image feature learning section 200B applies, in step ST74C, the lens distortion transform to the image SH acquired by the process in step ST73. In this case, the image feature learning section 200B applies the transform TR equivalent to the camera lens distortion based on the lens distortion data specified by the parameter indicating which of the plurality of pieces of camera lens distortion data is to be used, thus acquiring the transformed image SR.

Still further, the image feature learning section 200B proceeds with the process in step ST82 following the process in step ST74C. In step ST82, the image feature learning section 200B determines, based on the parameter indicating whether to convert the progressive image to an interlaced image generated in step ST72C, whether to do so. When the progressive image is converted to an interlaced image, the image feature learning section 200B applies, in step ST75, the transform TI to the transformed image SR acquired in step ST74C, thus converting the progressive image SR to an interlaced image and acquiring the transformed image SI=TI (SR, δᵢ).

The image feature learning section 200B proceeds with the process in step ST76 following the process in step ST75. On the other hand, if the progressive image is not converted to an interlaced image in step ST82, the image feature learning section 200B proceeds immediately with the process in step ST76. Although not described in detail, all the other steps of the flowchart shown in FIG. 18 are the same as those of the flowchart shown in FIG. 12.

As described above, if the step is included to determine whether the progressive image is converted to an interlaced image, it is possible to acquire a feature point dictionary that takes into consideration both the interlaced and progressive images. Further, if a transformed image is used which has been subjected to lens distortion transforms of a plurality of cameras, it is possible to acquire a feature point dictionary that takes into consideration the lens distortions of a plurality of cameras.

The image processor 100 shown in FIG. 2 supports both interlaced and progressive input images and deals with any of a plurality of lens distortions by using this feature point dictionary. In other words, regardless of the camera characteristics, it is possible to properly find the corresponding feature points between the input and reference images, thus permitting the input image to be properly merged with a composite image. This eliminates the need for users to set specific camera characteristics (interlaced/progressive and lens distortion), thus providing improved ease of use.

It should be noted that the present technology may have the following configurations.
(1)

An image processor including:

a feature point extraction section adapted to extract the feature points of an input image that is an image captured by a camera;

a correspondence determination section adapted to determine the correspondence between the feature points of the input image extracted by the feature point extraction section and the feature points of a reference image using a feature point dictionary generated from the reference image in consideration of a lens distortion of the camera;

a feature point coordinate distortion correction section adapted to correct the coordinates of the feature points of the input image corresponding to the feature points of the reference image determined by the correspondence determination section based on lens distortion data of the camera;

a projection relationship calculation section adapted to calculate the projection relationship between the input and reference images according to the correspondence determined by the correspondence determination section and based on the coordinates of the feature points of the reference image and the coordinates of the feature Points of the input image corrected by the feature point coordinate distortion correction section;

a composite image coordinate transform section adapted to generate a composite image to be attached from a composite image based on the projection relationship calculated by the projection relationship calculation section and the lens distortion data of the camera; and

an output image generation section adapted to merge the input image with the composite image to be attached generated by the composite image coordinate transform section and acquire an output image.
(2)

The image processor of feature (1), in which

the feature point dictionary is generated in consideration of not only the lens distortion of the camera but also an interlaced image.
(3)

An image processing method including:

extracting the feature points of an input image that is an image captured by a camera;

determining the correspondence between the feature points of the input image extracted and the feature points of a reference image using a feature point dictionary generated from the reference image in consideration of a lens distortion of the camera;

correcting the determined coordinates of the feature points of the input image corresponding to the feature points of the reference image based on lens distortion data of the camera;

calculating the projection relationship between the input and reference images according to the determined correspondence and based on the coordinates of the feature points of the reference image and the corrected coordinates of the feature points of the input image;

generating a composite image to be attached from a composite image based on the calculated projection relationship and the lens distortion data of the camera; and

merging the input image with the generated composite image to be attached and acquiring an output image.
(4)

A program allowing a computer to function as:

a feature point extraction section adapted to extract the feature points of an input image that is an image captured by a camera;

a correspondence determination section adapted to determine the correspondence between the feature points of the input image extracted by the feature point extraction section and the feature points of a reference image using a feature point dictionary generated from the reference image in consideration of a lens distortion of the camera;

a feature point coordinate distortion correction section adapted to correct the coordinates of the feature points of the input image corresponding to the feature points of the reference image determined by the correspondence determination section based on lens distortion data of the camera;

a projection relationship calculation section adapted to calculate the projection relationship between the input and reference images according to the correspondence determined by the correspondence determination section and based on the coordinates of the feature points of the reference image and the coordinates of the feature points of the input image corrected by the feature point coordinate distortion correction section;

a composite image coordinate transform section adapted to generate a composite image to be attached from a composite image based on the projection relationship calculated by the projection relationship calculation section and the lens distortion data of the camera; and

an output image generation section adapted to merge the input image with the composite image to be attached generated by the composite image coordinate transform section and acquire an output image.
(5)

A learning device including: an image transform section adapted to apply at least a geometric transform using transform parameters and a lens distortion transform using lens distortion data to a reference image; and

a dictionary registration section adapted to extract a given number of feature points based on a plurality of images transformed by the image transform section and register the feature points in a dictionary.
(6)

The learning device of feature (5), in which

the dictionary registration section includes:

a feature point calculation unit adapted to find the feature points of the images transformed by the image transform section;

a feature point coordinate transform unit adapted to transform the coordinates of the feature points found by the feature point calculation unit into the coordinates of the reference image;

an occurrence frequency updating unit adapted to update the occurrence frequency of each off the feature points based on the feature point coordinates transformed by the feature point coordinate transform unit, for each of the reference images transformed by the image transform section; and

a feature point registration unit adapted to extract, of all the feature points whose occurrence frequencies have been updated by the occurrence frequency updating unit, an arbitrary number of feature points from the top in descending order of occurrence frequency and register these feature points in the dictionary.
(7)

The learning device of feature (5) or (6), in which

the image transform section applies the geometric transform and lens distortion transform to the reference image, and generates the plurality of transformed images by selectively converting the progressive image to an interlaced image.
(8)

The learning device of any one of features (5) to (7), in which

the image transform section generates the plurality of transformed images by applying the lens distortion transform based on lens distortion data randomly selected from among a plurality of pieces of lens distortion data.
(9)

A learning method including:

applying at least a geometric transform using transform parameters and a lens distortion transform using lens distortion data to a reference image; and

extracting a given number of feature points based on a plurality of transformed images and registering the feature points in a dictionary.
(10)

A program allowing a computer to function as:

an image transform section adapted to apply at least a geometric transform using transform parameters and a lens distortion transform using lens distortion data to a reference image; and

a dictionary registration section adapted to extract a given number of feature points based on a plurality of images transformed by the image transform section and register the feature points in a dictionary.

The present disclosure contains subject matter related to that disclosed in Japanese Priority Patent Application JP 2012-014872 filed in the Japan Patent Office on Jan. 27, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image, processor comprising:
a feature point extraction section adapted to extract the feature points of an input image that is an image captured by a camera;
a correspondence determination section adapted to determine the correspondence between the feature points of the input image extracted by the feature point extraction section and the feature points of a reference image using a feature point dictionary generated from the reference image in consideration of a lens distortion of the camera;
a feature point coordinate distortion correction section adapted to correct the coordinates of the feature points of the input image corresponding to the feature points of the reference image determined by the correspondence determination section based on lens distortion data of the camera;
a projection relationship calculation section adapted to calculate the projection relationship between the input and reference images according to the correspondence determined by the correspondence determination section and based on the coordinates of the feature points of the reference image and the coordinates of the feature points of the input image corrected by the feature point coordinate distortion correction section;
a composite image coordinate transform section adapted to generate a composite image to be attached from a composite image based on the projection relationship calculated by the projection relationship calculation section and the lens distortion data of the camera; and
an output image generation section adapted to merge the input image with the composite image to be attached generated by the composite image coordinate transform section and acquire an output image.

2. The image processor of claim 1, wherein
the feature point dictionary is generated in consideration of not only the lens distortion of the camera but also an interlaced image.

3. An image processing method comprising:
extracting the feature points of an input image that is an image captured by a camera;
determining the correspondence between the feature points of the input image extracted and the feature points of a reference image using a feature point dictionary generated from the reference image in consideration of a lens distortion of the camera;
correcting the determined coordinates of the feature points of the input image corresponding to the feature points of the reference image based on lens distortion data of the camera;
calculating the projection relationship between the input and reference images according to the determined correspondence and based on the coordinates of the feature points of the reference image and the corrected coordinates of the feature points of the input image;
generating a composite image to be attached from a composite image based on the calculated projection relationship and the lens distortion data of the camera; and
merging the input image with the generated composite image to be attached and acquiring an output image.

4. A program allowing a computer to function as:
a feature point extraction section adapted to extract the feature points of an input image that is an image captured by a camera;
a correspondence determination section adapted to determine the correspondence between the feature points of the input image extracted by the feature point extraction section and the feature points of a reference image using a feature point dictionary generated from the reference image in consideration of a lens distortion of the camera;
a feature point coordinate distortion correction section adapted to correct the coordinates of the feature points of the input image corresponding to the feature points of the reference image determined by the correspondence determination section based on lens distortion data of the camera;
a projection relationship calculation section adapted to calculate the projection relationship between the input and reference images according to the correspondence determined by the correspondence determination section and based on the coordinates of the feature points of the reference image and the coordinates of the feature points of the input image corrected by the feature point coordinate distortion correction section;
a composite image coordinate transform section adapted to generate a composite image to be attached from a composite image based on the projection relationship calculated by the projection relationship calculation section and the lens distortion data of the camera; and
an output image generation section adapted to merge the input image with the composite image to be attached generated by the composite image coordinate transform section and acquire an output image.

5. A learning device comprising:
an image transform section adapted to apply at least a geometric transform using transform parameters and a lens distortion transform using lens distortion data to a reference image; and
a dictionary registration section adapted to extract a given number of feature points based on a plurality of images transformed by the image transform section and register the feature points in a dictionary.

6. The learning device of claim 5, wherein
the dictionary registration section includes:
a feature point calculation unit adapted to find the feature points of the images transformed by the image transform section;
a feature point coordinate transform unit adapted to transform the coordinates of the feature points found by the feature point calculation unit into the coordinates of the reference image;
an occurrence frequency updating unit adapted to update the occurrence frequency of each of the feature points based on the feature point coordinates transformed by the feature point coordinate transform unit for each of the reference images transformed by the image transform section; and
a feature point registration unit adapted to extract, of all the feature points whose occurrence frequencies have been updated by the occurrence frequency updating unit, an arbitrary number of feature points from the top in descending order of occurrence frequency and register these feature points in the dictionary.

7. The learning device of claim 5, wherein
the image transform section applies the geometric transform and lens distortion transform to the reference image, and generates the plurality of transformed images by selectively converting the progressive image to an interlaced image.

8. The learning device of claim 5, wherein
the image transform section generates the plurality of transformed images by applying the lens distortion transform based on lens distortion data randomly selected from among a plurality of pieces of lens distortion data.

9. A learning method comprising:
applying at least a geometric transform using transform parameters and a lens distortion transform using lens distortion data to a reference image; and
extracting a given number of feature points based on a plurality of transformed images and registering the feature points in a dictionary.

10. A program allowing a computer to function as:
an image transform section adapted to apply at least a geometric transform using transform parameters and a lens distortion transform using lens distortion data to a reference image; and
a dictionary registration section adapted to extract a given number of feature points based on a plurality of images transformed by the image transform section and register the feature points in a dictionary.
